(19) United States
(12) Patent Application Publication
(10) Pub. No.: US 2014/0220305 A1
(43) Pub. Date: Aug. 7, 2014

(54) ARTICLE OF MANUFACTURE AND METHOD FOR ITS PREPARATION

(71) Applicant: Ramy Zack, Rishon Le-Zion (IL)

(72) Inventor: Ramy Zack, Rishon Le-Zion (IL)

(73) Assignee: GREEN NEIGHBORHOOD LIMITED PARTNERSHIP, Ramat Gan (IL)

(21) Appl. No.: 14/240,556

(22) PCT Filed: Aug. 23, 2012
(86) PCT No.: PCT/IL2012/050322

§ 371 Date: Feb. 24, 2014

Related U.S. Application Data
(60) Provisional application No. 61/526,956, filed on Aug. 24, 2011.

(51) Int. Cl. B32B 25/08; B32B 3/30; B29C 43/00

(52) U.S. Cl. CPC B32B 25/08; B29C 43/003; B32B 3/30
USPC 428/172; 264/268

(57) ABSTRACT

Provided is an article of manufacture and a method for its production, the article of manufacture including at least one support element including fiber reinforced polyester (FRP), the at least one support element constructed in a form of a base and at least two projections extending from the base, the base and at least two projections forming together at least one compartment which is filled with a composite material including rubber particles.

### FIELD OF THE INVENTION

This invention relates in general to green technology, and in particular to the use of used rubber, e.g. vulcanized rubber from used or recycled tires, for manufacturing various articles.

### BACKGROUND OF THE INVENTION

The use of waste materials and recycling has grown in recent years mainly due to the growing interest in green technology. One example for waste material that is constantly recycled is tires. The tire is a commonly used source for crosslinked or vulcanized rubber.

Various publications exists that describe methods for manufacturing products from recycled rubber. These include, inter alia, U.S. Pat. No. 6,766,963 describing a method for the manufacture of a railroad crosstie from recycled rubber; US Patent application publication No. 2010/230861 describing systems and methods for manufacturing crumb rubber products, such as a floor mat, for decorative or industrial applications; US Patent application publication No. 2010/00704 describing methods for making shapeable composite materials or shaped articles from recycled materials for example ground tire rubber; U.S. Pat. No. 6,972,144 describing a composite structural material comprising a core material which includes polyurethane foam and optionally filled with granulated rubber and/or expandable polymer beads and finally, Japanese patent application publication No. JP2003213614 describing a block comprising a double structure of an elastic body layer comprising rubber chips, fragments of thermosetting resin molding and a urethane resin as a binder and a rigid body layer comprising solidified thermosetting resin molding with a thermosetting resin as a binder.

### SUMMARY OF THE INVENTION

In accordance with a first aspect, the present disclosure provides an article of manufacture comprising at least one support element comprising fiber-reinforced polyester (FRP), the at least one support element constructed in a form of a base and at least two projections extending from the base, the base and at least two projections forming together at least one compartment which is filled with a composite material comprising rubber particles.

In accordance with a second aspect, the present disclosure provides a method of manufacture an article, the method comprising:
(a) providing at least one support element, the support element comprising fiber-reinforced polyester (FRP) constructed in a form comprising a base and at least two projections extending from the base, the base and the at least two projections forming together at least one compartment;
(b) placing the at least one support element on a steel casting mold (SCM) while heating the SCM;
(c) introducing into the steel casting mold carrying the at least one support element a pulp composite material comprising rubber particles;
(d) compressing the pulp composite material against the at least one support element;
(e) allowing the SCM to cool down; and
(f) releasing compressing, whereby the article of manufacture comprising the at least one support element and the composite material is formed.

In yet a third aspect, the present disclosure provides an article of manufacture whenever obtained by the method disclosed herein.

In yet a further aspect, the present disclosure also concerns the various uses of the article of manufacture.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1A-1B are perspective side views of support elements in accordance with some embodiments of the invention, where FIG. 1A illustrates a support element comprising a base and three projections, while FIG. 1B illustrates two, spaced apart support elements, each having a “U” shape profile.

FIG. 2 is cross sectional view of a support element according to FIG. 1A filled with composite material.

FIG. 3 is a side view of an illustrated support element as shown in FIG. 1A placed within a steel casting mold (SCM) having end plugs circumventing the support element.

FIG. 4 is a cross sectional view of a SCM holding a support element as shown in FIG. 1A, and filled with composite material, and a compression piston applied thereto.

### DETAILED DESCRIPTION OF SOME NON-LIMITING EMBODIMENTS

The present disclosure relates to articles of manufacture comprising recycled materials, and more specifically to recycled tire rubber. The articles of manufacture are unique in that they are relatively light, have a high cantilever strength and stiffness and are thus suitable to carry heavy loads.

Thus, in accordance with one aspect of the present disclosure, there is provided an article of manufacture comprising a support element comprising fiber reinforced polyester (FRP), the support element constructed in a form of a base and at least two projections extending from the base, the base and at least two projections forming together at least one compartment which is filled with a composite material comprising rubber particles.

The term “article of manufacture” should be understood to have the meaning as known in the art, namely, a product of a manufacturing process. In accordance with the invention, the article of manufacture is characterized by unique properties such as low bulk density, high strength allowing it to withstand heavy loads. Such properties are measurable by acceptable physical techniques such as bending strength test.

In one embodiment, the article of manufacture is characterized by a bending strength of between about 50 MPa to 120 MPa, preferably 50-110 MPa. A bending strength at this range is indicative that the article of manufacture can resist deformation under load of 50 MPa to 120 MPa, preferably 50 MPa to 110 MPa. For example, the bending strength of the product Plywood (timber made from thin sheets of wood veneer) is up to 85 MPa.

In a further embodiment, the article of manufacture is characterized by an elastic modulus of at least 3,000 MPa, and in some embodiments between 3,000 MPa and 7,000 MPa, in some specific embodiments between 6,000 MPa and 6,500 MPa and one particular embodiment the elastic modulus is about 6,230 MPa. The elastic modulus, also known by the term modulus of elasticity, defines the tendency of an article to be deformed elastically (i.e., non-permanently) when a force is applied to it.

In yet a further embodiment, the article of manufacture is characterized by bulk density of between 1,300 kg/m³ to 1,400 kg/m³.

The article of manufacture comprises two main constituents, the support element comprising, and preferably consisting, of fiber reinforced polyester (FRP) and the composite material comprising rubber particles. As noted below, the composite material may include other additives.

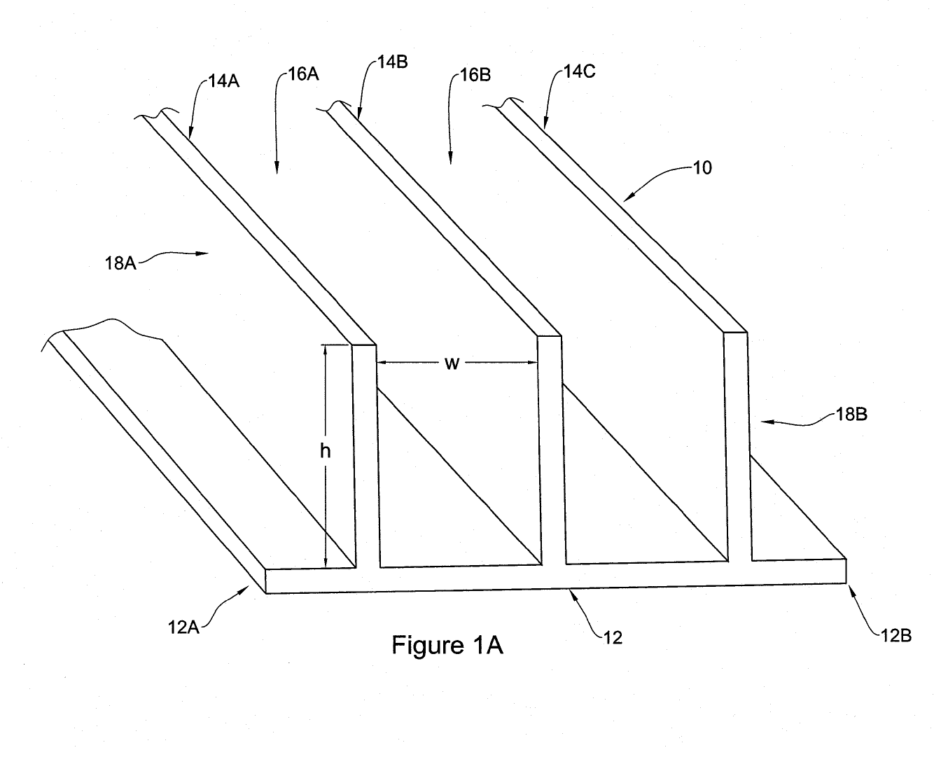

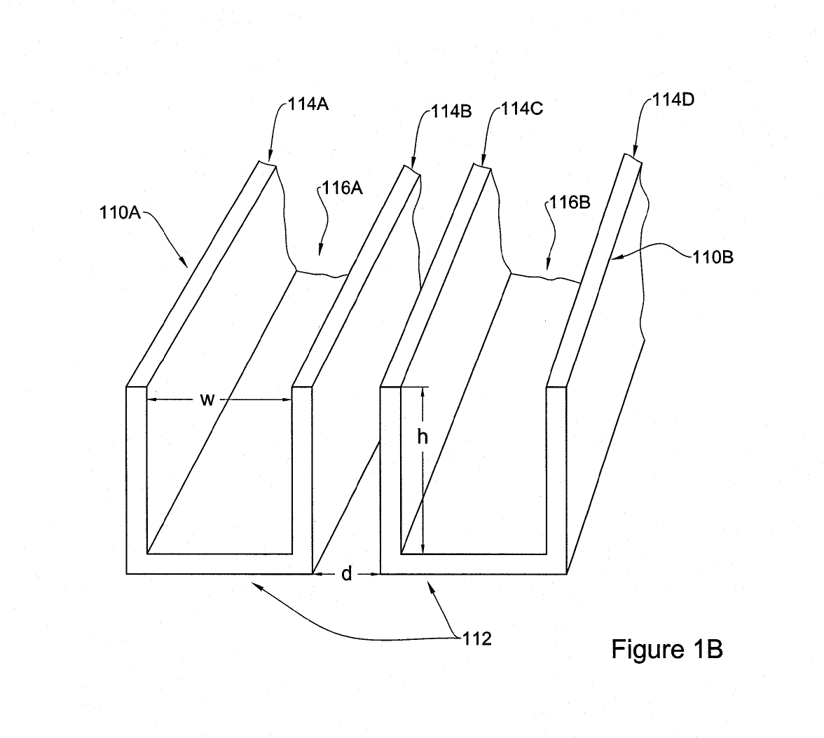

The support element is used, as such, to support the composite material once the latter hardens. The support element thus comprises voids for holding the composite material. The voids are formed from projections extending from a bottom portion of the support element. In this connection, reference is made to FIGS. 1A-1B which are schematic illustrations of two exemplary support element that may be used in the article of manufacture and method subject of the present disclosure and appended claims.

In FIG. 1A, there is illustrated a support element 10 comprising a base 12, extending from first end 12A to second end 12B and three spaced apart projections 14A, 14B and 14C extending upwardly from the upper surface of base 12. Each two neighboring projections 14A and 14B or 14B and 14C form therebetween a two-sided compartment 16A and 16B, while the two external projections 14A and 14C form two, open-end compartments 18A and 18B.

The support element 10 in FIG. 1A comprises three essentially identical and equally spaced apart projections 14A, 14B and 14C, which are also essentially parallel and perpendicular to base 12.

Each pair of projections such as 14A and 14B or 14B and 14C define a compartment height (h) from base 12 and compartment width (w) defined between facing surfaces of paired projections. Generally the height (h) may be in the range between 15 mm to 50 mm and the width (w) may be in the range between 7 mm and 35 mm In one preferred embodiment, the height (h) is in the range between 25 mm to 50 mm and the width (w) is in the range between 15 mm and 35 mm In the illustrated embodiment of FIG. 1A, the height (h) is 30 mm the width (w) is 19 nm and the width of the open end compartment is w/2, i.e. 8.5 mm

Further, base 12 of the support element 10 has a defined thickness range, which is generally between 2 to 5 mm Yet further, each projection has a thickness (which may be the same or different in the two or more projections of a particular element) and is generally between 2 to 5 mm

For simplicity, like reference numerals to those used in FIG. 1A, shifted by 100, 200, 300 are used to identify components having a similar function in any of the following figures. For example, component 12 in FIG. 1A is a base having the same function as base 112 in FIG. 1B.

Referring now to FIG. 1B, there are illustrated two, spaced apart, support elements 110A and 110B are illustrated, each having a U shape configuration, thus forming a set of four projections 114A, 114B, 114C and 114D. The two U shaped support elements form two compartments, 116A, and 116B. When using two or more support elements, as illustrated in FIG. 1B, the distance “d” between the support elements is within the range of “w”, namely at least between 7 mm to 35 mm

In the illustrated embodiment of FIG. 1B, the height (h) of each projection in the U-shaped support element is 30 mm and the width (w) of each compartment is 30 mm The distance between the two U-shaped support elements is within the range defined for “w”, being in this particular embodiment about 10 mm

While FIGS. 1A and 1B provide exemplary embodiments, it is to be understood that additional configurations are equally applicable, for instance, such configuration that includes a base with a plurality projections with different heights, different compartment widths, or a set of two or more support elements having, therebetween, different heights, different widths, etc.

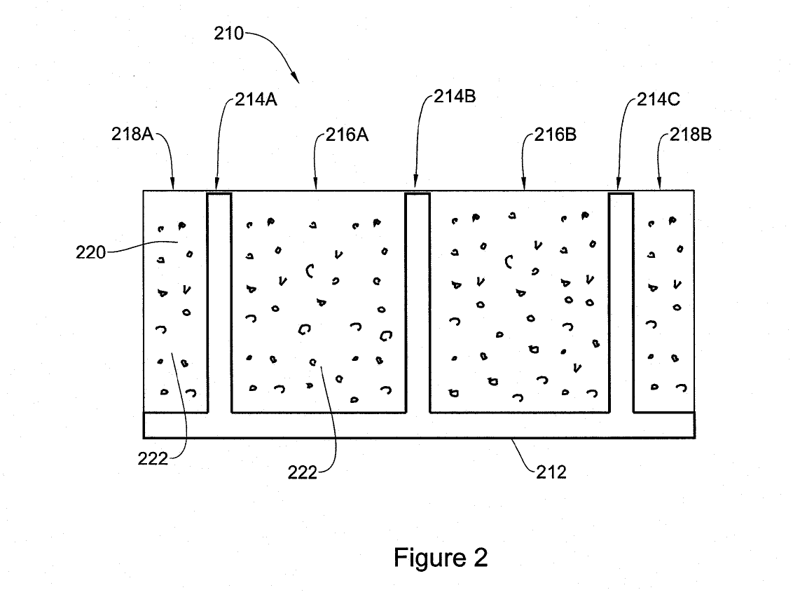

The compartments as well as the spaces formed therebetween and open end compartments are filled with a composite material comprising rubber particles. In this connection, reference is made to FIG. 2 showing a support element 210 having a base 212 and projections 214A, 214B and 214C, similar to the support element in FIG. 1A, where all compartments 216A, 216B, and open-end compartments 218A and 218B are filled with composite material 220 comprising the rubber particles 222.

In accordance with the invention, the support element comprises FRP profile and while is widely available in the market, it may also be prepared by experimental methods known in the field. For example, the FRP profile may be prepared by using unidirectional glass fibers, which are subjected to a pultrusion process by pulling the glass fibers together and dipping them into a resin bath comprising a resin composition comprising a mixture of polyester resin, a catalysts and a hardener. The resin impregnated fibers are then introduced into a steel-made pultrusion mold at a desired pre-determined shape where curing takes place and a support element is obtained.

With respect to the composite material, is to be understood that the “rubber particles” are breakdown products of rubber material. In some particular embodiments, the rubber particles comprise vulcanized recycled tire rubber. The particles may be obtained by shredding, chopping, crushing, mincing, etc. rubber containing items suitable for recycling. As appreciated, recycling processes of rubber typically carry out a first stage of shredding followed by removal of steel, reinforcing fibers and cotton. Accordingly, the rubber particles according to the invention are essentially free of steel and cotton.

The recycled rubber within the article of manufacture in accordance with the invention is vulcanized rubber. The term “vulcanized rubber” is to be understood as referring to any cross-linked rubber polymers. Rubber polymers are typically cross-linked hydrocarbon elastomers, such as polyisoprene (either natural rubber e.g. gum rubber or synthetic rubber) or cross-linked styrene-butadiene rubber (SBR). The cross-linking typically includes reaction of the rubber polymer with sulfur, peroxides or any other cross linking agent known to those versed in the art, during which individual polymer chains are covalently interlinked to each other to yield a three dimensional matrix. The vulcanization of the rubber polymers gradually transforms the elastomers into thermosets. The degree of vulcanization may vary from one rubber to the other, depending on the application of the vulcanized rubber.

It is to be understood that any vulcanized rubber at any degree of vulcanization may be used in the context of the present disclosure.

It should also be noted that the vulcanized rubber may comprise a portion of non-vulcanized or devulcanized rubber, e.g. when the source of vulcanized rubber is rubber residues and discarded vulcanized rubber from rubber manufacturing plants. Typically, non-vulcanized or de-vulcanized rubber would not exceed more than 10% or even 5% or even as low as 1% of the total weight of the vulcanized rubber mass.

The vulcanized rubber may also comprise rubber additives such as fillers and fibers including residues or contaminants to which the rubber was exposed to during vulcanization reaction, during its use, or processing (e.g. retreading, recycling treatment or size reduction into crumb rubber).

Thus, it is to be understood that when referring to vulcanized rubber, the latter may be less than 100% pure and may comprise small amounts of other residues in an amount of between 0.1 and 20% w/w of the total weight of the vulcanized rubber, at times between 0.5 and 10% w/w residues, or between 1 and 5% w/w residues. These residues include tire cords, steel, silica, anti-tackifying agents, oil, sand, iron, ash, and calcium carbonate.

In some particular embodiments, the vulcanized rubber is from disposed vulcanized rubber products, such as, without being limited thereto, used tires, bumpers, shoe soles, latex and rubber gloves, conveyor belts and may also arrive from industrial rubber residues and discarded vulcanized rubber from rubber manufacturing plants.

In a particular embodiment, the rubber particles are recycled tires. Recycled tires may be in the form of crumb rubber, tire debris, tire slits, tire chips, ground tire rubber, crumb tire rubber, tire shreds, tire powder, tire cords etc.

In one embodiment, the recycled tires are crumb rubber.

Crumb rubber is to be understood as referring to rubber particles (e.g. scrap tires) that are irregularly shaped with an average size from 4.75 mm to less than 0.075 mm.

According to some particular embodiments, the rubber particles have a size of between 0.5 mm and 10 mm, preferably between 0.5 mm and 5 mm. In some particular example, the rubber particles have a round shape and the size corresponds to the particle's diameter.

Needless to note that the size and shape may be controlled by the process of shredding, the equipment and condition used etc. For example, the production of rubber particles may be achieved by granulators, hammer mills, or fine grinding machines, where granulators typically produce particles that are regularly shaped and cubical with a comparatively low-surface area.

The rubber particles may also be obtained from commercial suppliers. Thus, in the context of the present invention also commercially available rubber particles are included and applicable. Exemplary recycled tire suppliers include, without being limited thereto ETRA (www.ETRA-EU.org), EXIMLINK (Austria); KAHL (Germany).

In some embodiments, the vulcanized rubber originates from virgin material, either natural or synthetic.

According to some embodiments, the ratio between the FRP and the composite material in the manufactured article is of between 15:85 and 35:65. In some specific embodiments, the ratio between the FRP and the composite material in the manufactured article was 29:71.

The composite material also comprises a chemical binder and a hardener.

A chemical binder as used herein includes any non-natural adhesive or glue. In some embodiments, the chemical binder according to the invention is a thermoplastic binder. Thermoplastic binder also known as hot adhesive or hot melt adhesive, may be applied in a molten form that solidifies on cooling to form strong bonds between a wide ranges of materials.

In accordance with some embodiments, the chemical binder is a thermoplastic elastomer, such as, without being limited thereto, a thermoplastic polyester elastomer.

Thermoplastic elastomer may be selected from a group consisting of a thermoplastic styrenic block copolymer, a thermoplastic polyolefin blend, a thermoplastic blend of polypropylene with crosslinked rubber (thermoplastic vulcanizates), thermoplastic polyurethane, thermoplastic polyester and a thermoplastic polyamide.

Non-limiting examples of thermoplastic elastomers that can be used as binders include the following commercially available (and Trade Marked) products: Arnitel, Engage, Hytrel, Kraton, Pebax, Pellethane, Riteflex, Styroflex, Alcryn, Dryflex, Evoprene, Forprene, Geolast, Mediprene, Santoprene and Sarlink.

According to a specific embodiment, the chemical binder is Hytrel™

An additional possible chemical binder is the thermoplastic binder ethylene-vinyl acetate.

The composite material may also comprise a hardener, namely, a substance that is added to the rubber particles and binder in order to facilitate in the hardening of the composite. Without being limited thereto, a hardener may be selected from a group consisting of silica powder, quartz silica sand and silica granules. According to some preferred embodiments, the hardener is silica granules.

According to some embodiments, the composite material comprises between 70%-95% (w/w) rubber particles, the remainder 30%-5%, respectively, comprising non-rubber components. In some preferred embodiments, the composite material comprises, between 85%-95% (w/w) rubber particles, the rest, 15%-5% comprising the non-rubber components.

The non-rubber component, being no more than 30% of the composite material, typically comprises 75% binder, 10% hardener, 5% water and 10% other additives as detailed below.

For example, a composite material composition may comprise 70% rubber particles and the rest 30% may be divided to include about 22.5% binder, about 3% hardener, about 3% additives and about 1.5%water. Further, as an example, a composite material composition comprising 95% rubber particles, may be divided to include about 3.75% binder, about 0.5% hardener, about 0.5% additives and about 0.25% water.

Notwithstanding the above, the additives, such as sawdust (typically wetted, albeit not dripping), hydrated magnesium silicate, and flame retardant (e.g. aluminum hydroxide (ATH), magnesium hydroxide (MDH), and boron compounds such as borates).

The manufacturing of the article subject of the present invention involves a method comprising the following operations:
(a) providing a support element comprising fiber reinforced polyester (FRP) constructed in a form comprising a base and at least two projections extending from the base, the base and the at least two projections forming together at least one compartment;
(b) placing the support element on a steel casting mold (SCM) while heating the SCM;
(c) introducing into the at least one compartment a pulp composite material comprising rubber particles;
(d) compressing the composite material against the support element
(e) allowing the SCM to cool down; and
(e) releasing compressing, whereby the article of manufacture comprising the support element and the composite material is formed.

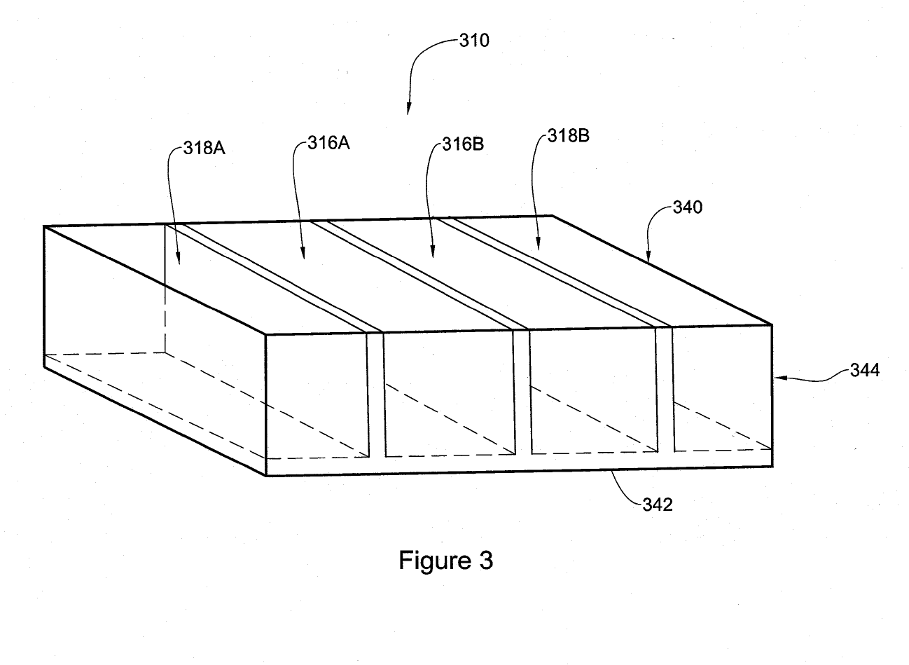

Accordingly, the support element having the characteristics as detailed above, is placed in a SCM, such as a steel container in the form of a tray comprising suitable end plugs, for example in the form of a wall, that circumferentially enclose the support element. As a result, the various compartments are fully side-walled. In this connection, reference is made to FIG. 3 schematic illustration a support element 310 placed within a SCM 340, the SCM 340 having a base 342 end plugs/side walls 344 circumventing the support element and thus enclosing compartments 316A, 316B, and open-end compartments 318A and 318B.

The SCM is heated to temperature between 55° C. and 80° C., preferably between 55° C. to 65° C., more preferably to about 60° C. The temperature of the SCM may be determined by dedicated temperature sensors, as known in the art.

In addition to heating the SCM, also the composite material is prepared by mixing the various components, as detailed above. The mixed composite material is also heated, the heating may take place while mixing or thereafter. At any rate, heating is to a temperature of between 50° C. and 80° C., preferably between 55° C. and 65° C. It is appreciated that the mixed composite material is in the form of a pulp (playable form).

Once the SCM and the composite material are set to the desired temperature, the pulp composite material is introduced into the compartments of the support element.

In some embodiments, the pulp composite material is added in an amount sufficient to essentially cover at least a portion of projections (i.e. not reaching the maximal height of the projection, and thus not fully filling the compartments). In some other embodiments, the pulp composite material is added in an amount allowing coverage of all projections.

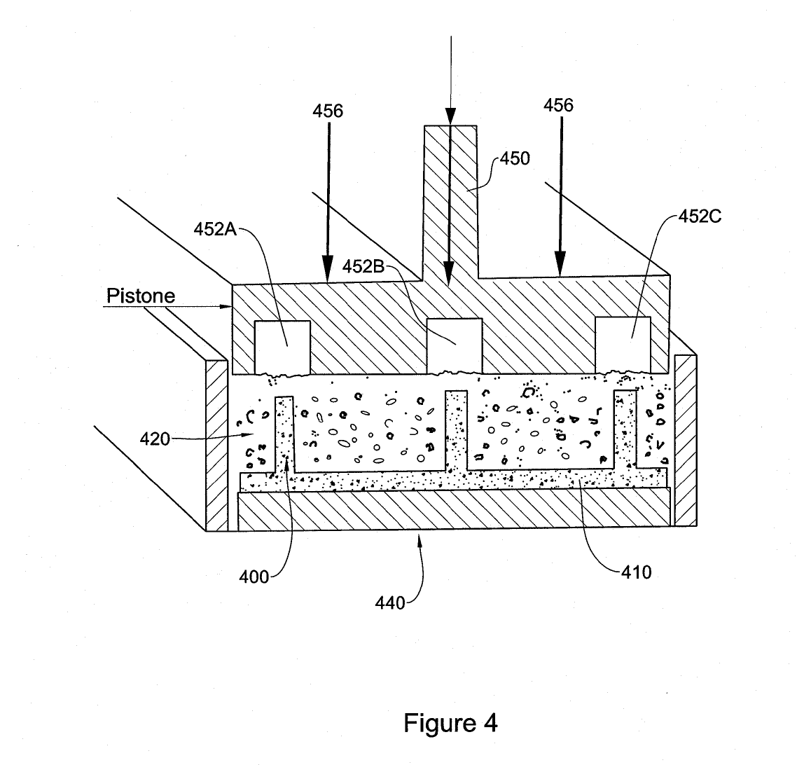

Once the composite material is introduced into the support element, the composite material is compressed. Compression may be performed by any commonly used compression piston, adapted to press the composite material in the compartments, against the support element's base. The structure of the piston may be configured to adapt to the shape of the support element, i.e. to the number, dimensions and arrangement of the projections and compartments. As an example only, reference is made to FIG. 4, schematically illustrating a support element 410, placed within a SCM 440 holding a composite material 420 and a compression piston 450 having depressions or indentations 452A, 452B and 452C configured to accommodate the projections. Upon operation, the piston applies pressure to the composite material in the direction of arrows 456. The pressure applied by the compression piston is typically in the range of between 1.2 MPa and 2.0 MPa.

Concomitant with or shortly after applying the pressure by the compression piston, the heating of the SCM is terminated and compression continues until the SCM's temperature lowers down, actively (e.g. by a heat control device, such as cooler) or passively, the temperature is lowered to a temperature between 5° C. to 45° C., preferably to 40° C. or any temperature below, e.g. room temperature. During compression, the composite material cures, and once the SCM reaches the desired temperature, the piston may be removed whereby the article of manufacture is obtained.

As may be appreciated by those versed in the art, the article of manufacture may be produced in a variety of shapes and forms. In accordance with one embodiment, the article of manufacture is formed in a form of a laminate. The laminate may be used for a variety of applications, including, without limited thereto, to flooring, tiles, roofing, ceiling, walls, covering, cladding, boards, fencing, plates, railroad ties (also known as railway sleeper), noise insulating materials, structure frames, machines and vehicle shield parts, vehicle and road bumpers and bullet-proof shielding, all being tailored to customer requirements.

The flooring, tiles, roofing, ceiling, walls, covering, cladding, boards may be used for example for containers, buildings, and housing namely, in the building industry, housing industry or container manufacturing.

In some specific embodiments, the article of manufacture is used for flooring a container. In some embodiments, the container is a shipping container. The shipping container may be used for sea shipping or surface shipping.

Non limiting examples of shipping container are twenty-foot equivalent unit, 40 foot container or high cube container.

Due to the unique characteristics of the article of manufacture, it may be used also for noise absorbance and/or temperature isolation.

As used herein, the forms “a”, “an” and “the” include singular as well as plural references unless the context clearly dictates otherwise. For example, the term “a support element” includes one or more support elements which may be used in the article of manufacture.

Further, as used herein, the term “comprising” is intended to mean that the composite material includes the recited constituents, e.g. rubber particles, binder and hardener, but is not excluding other materials such as the above mentioned additives. The term “consisting essentially of” is used to define compositions which include the recited elements but exclude other elements. “Consisting of” shall thus mean excluding more than trace amounts of any element other than those recited. Embodiments defined by each of these transition terms are within the scope of this invention.

Further, all numerical values, e.g. when referring the amounts or ranges of the elements or other parameters recited are approximations which are varied (+) or (−) by up to 20%, at times by up to 10% of from the stated values. It is to be understood, even if not always explicitly stated that all numerical designations are preceded by the term “about”.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DESCRIPTION OF SOME NON-LIMITING EXAMPLES

### Example 1

### Preparation of the Rubber Containing Composite Material (Pulp)

Vulcanized recycled shredded rubber particles which are free of steel and of cotton fluff were obtained at sizes between 0 5 mm to 5 mm (European Tire Recycling Association (ETRA), Belgium, and France).

The shredded recycled rubber particles (88%) were mixed with 9% w/w of the thermoplastic polyester elastomer binder Hytrel® (DuPont™), with 1.2% v/w silica powder, sawdust (0.6%v/w), and bromide oxide (0.6%w/w) The sawdust was water-sprayed, to add to the mixture 0.6% humidity, resulting in a wet but non-dripping.

The above constituents were heated to a temperature of 55° C-65° C. while continuously being mixed to obtain a homogonous pulp composite material.

### Example 2

### Combining Rubber with Fiber Reinforced Polyester (FRP) Profile

In the tested example, two FRP profiles, having a configuration as illustrated in FIG. 1B, were placed on a steel casting mold (SCM), such that a space is formed therebetween, with a distance between the two support elements being 10 mm The SCM peripherally encloses the two FRP profiles (i.e. the two support elements) to form voids into which rubber composition may be poured. The SCM was heated to a temperature of about 60° C. which caused heating of the FRP profiles to approximately the same temperature. The rubber composite material was then introduced into the voids of the heated profiles.

The heating was stopped and a compression piston was then used to apply a pressure of about 1.2-2 MPa onto the composite material-filled FRP profile.

Pressure by the compression piston was applied until the temperature of the SCM reached 40° C.

The resulting article of manufacture comprised ˜30-40% (w/w) FRP profile and ˜60-70% (w/w) rubber pulp.

### Example 3

### Characterization of the Article of Manufacture

A sample of the article of manufacture of Example 2 (dimensions of width: 7 cm, height: 3 cm and length: 26 cm) was placed on a tensile testing device (such as an hydraulic press)

The distance between the two prisms in the device was set to 235 mm and four different loads were applied onto the sample. Table 1 summarizes the different loads and resulting deflections.

TABLE 1
sample deflections

| Test number | Load (Kg force) | Deflection (mm) |
|---|---|---|
| 1 | 1168 | 3.35 |
| 2 | 1433 | 4.20 |
| 3 | 1650 | 5.0 |
| 4 | 1890 | 5.20 |

A load of 1890 kg was set as the upper limit load in which the sample preserved the sample elastic modulus. As shown, at a load of 1890 Kg a deflection of 5.2 mm was obtained.

Based on the dimensions of the sample, distance between the prisms and the measured deflection, a bending stretch of 105 MPa and Elastic modulus of 6,230 MPa were determined for test #4.

1. An article of manufacture, comprising: at least one support element comprising fiber reinforced polyester (FRP), the at least one support element constructed in a form of a base and at least two projections extending from the base, the base and at least two projections forming together at least one compartment which is filled with a composite material comprising rubber particles.

2. The article of manufacture of claim 1, characterized by at least one of
bending strength of between about 50 MPa to 120 MPa; and
elastic modulus of at least 3,000 MPa.

3.-5. (canceled)

6. The article of manufacture of claim 1, having a bulk density of from 1,300 kg/m³ to 1,400 kg/m³.

7. The article of manufacture of claim 1, wherein the at least two projections extend upwardly from the base.

8.-10. (canceled)

11. The article of manufacture of claim 1, comprising a plurality of support elements having a space therebetween, and comprising composite material filled in the space formed between the plurality of support elements.

12.-14. (canceled)

15. The article of manufacture of claim 1, comprising at least one support element consisting of a base and three projections.

16.-20. (canceled)

21. The article of claim 1, wherein the ratio between the FRP and the composite material is from 15:85 to 35:65 (v/v).

22. A method of manufacture of an article, comprising:
(a) providing at least one support element comprising fiber reinforced polyester (FRP) constructed in a form comprising a base and at least two projections extending from the base, the base and the at least two projections forming together at least one compartment;
(b) placing the at least one support element on a steel casting mold (SCM) while heating the SCM;
(c) introducing into the steel casting mold carrying the at least one support element a pulp composite material comprising rubber particles;
(d) compressing the pulp composite material against the support element;
(e) allowing the SCM to cool down; and
(f) releasing compressing, whereby the article of manufacture comprising the at least one support element and the composite material is formed.

23. The method of claim 22, wherein heating the SCM comprises heating to a temperature from 50° C. to 80° C.

24. The method of claim 22, wherein said allowing the SCM to cool is to a temperature of at most 40° C.

25.-27. (canceled)

28. The method of claim 22, comprising a plurality of projections forming a plurality of compartments having the same or different dimensions.

29. The method of claim 22, wherein a plurality of support elements are placed in the steel casting mold such that a space is formed therebetween.

30. The method of claim 29, wherein the composite material is introduced into the compartment of each support element and in the space formed between the plurality of support elements.

31.-46. (canceled)

47. The method of claim 22, wherein the composite material comprises a hardener is selected from silica powder, quartz silica sand, and silica granules.

48. (canceled)

49. The method of claim 22, wherein the composite material comprises from 70% to 95% (w/w) rubber particles.

50. (canceled)

51. The method of claim 22 wherein the composite material is prepared at a temperature from 55° C. to 65° C.

52. (canceled)

53. The method of claim 22, wherein introducing an amount of pulp composite material to the at least one compartment is such that the volume ratio between the FRP and the composite material is from 15:85 to 35:65.

54.-55. (canceled)

56. The method of claim 22, wherein compressing comprises compressing the pulp composite material against the base of the at least one support element.

57.-59. (canceled)

60. The article of manufacture of claim 1, in a form of a laminate.

61.-63. (canceled)

64. An article of manufacture obtained by the method of claim 22, in a form of a laminate.
